(19) United States
(12) Patent Application Publication
(10) Pub. No.: US 2009/0106811 A1
(43) Pub. Date: Apr. 23, 2009

(54) INFORMATION PROCESSING APPARATUS, INFORMATION PROCESSING METHOD, PROGRAM, AND RECORDING MEDIUM ON WHICH SUCH PROGRAM IS RECORDED

(75) Inventors: Tetsujiro KONDO, Tokyo (JP); Yoshinori Watanabe, kanagawa (JP); Tsuyoshi Tanaka, Kanagawa (JP); Takuro Ema, Tokyo (JP); Yusuke Akiwa, Saitama (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sony Corporation, Tokyo (JP)

(21) Appl. No.: 12/203,493

(22) Filed: Sep. 3, 2008

(30) Foreign Application Priority Data
Oct. 22, 2007 (JP) 2007-274495

(51) Int. Cl. H04N 7/173

(52) U.S. Cl. 725/131

(57) ABSTRACT

Disclosed is an information processing apparatus that includes an obtaining unit obtaining first contents and second contents, a storage storing the first contents and second contents obtained by the obtaining unit, and an information processor reading the first contents and second contents from the storage and outputting the second contents, while causing the second contents to precede the first contents a predetermined time, to be superimposed on the first contents.

### CROSS REFERENCES TO RELATED APPLICATIONS

The present invention contains subject matter related to Japanese Patent Application JP 2007-274495 filed in the Japanese Patent Office on Oct. 22, 2007, the entire contents of which being incorporated herein by reference.

### BACKGROUND OF THE INVENTION

1. Field of the Invention

The present invention relates to an information processing apparatus, an information processing method, a program, and a recording medium on which such program is recorded that can suitably present a plurality of contents.

2. Description of the Related Art

Recent television receivers, having incorporated numerous functions, not only receive a data television broadcasting from a broadcast station to display screen images as a television broadcasting program, but also demonstrate various other functions.

For example, Japanese Unexamined Patent Application Publication No. 2005-347871 discloses a television receiver that includes: first and second tuners each individually receiving television broadcasting; a first video decoder decoding screen image data multiplexed to television broadcasting received by the first tuner and outputting the image data as screen images for a currently presenting program; and a second video decoder decoding part of screen image data multiplexed to television broadcasting received by the second tuner and outputting the image data as screen images for a counterprogram, so that the screen images for the counterprogram are added to program information on the television broadcasting received by the first tuner to output the resulting program information.

The aforementioned television receiver having simple configuration, will provide a user a television broadcasting program (counterprogram) other than currently presenting program (currently presenting program), contents of which the user can easily follow.

### SUMMARY OF THE INVENTION

In an experiment conducted by the present applicant, the result demonstrated that audience efficiently understood a plurality of contents (image, sound) of the program divided into time segments when simultaneously viewing the contents. This result implies that presenting the contents divided into time segments is effective when making the audience effectively understand the contents. In addition, a similar experiment also demonstrated that audience understood the contents of the program more quickly when they had some knowledge in advance, which can be even the slightest of subsequent contents of the program.

According to embodiments of the invention, audience can efficiently understand contents of the television broadcasting program.

An information processing apparatus according to a first embodiment of the invention includes: an obtaining unit obtaining first contents and second contents; a storage storing the first contents and second contents obtained by the obtaining unit; an information processor reading the first contents and second contents from the storage and outputting the second contents, while causing the second contents to precede the first contents a predetermined time, to be superimposed on the first contents.

In this embodiment, the first contents and second contents not only indicate the contents of various programs with different tiles, but also include the contents of the identical program having the same tile but differing in time sequence.

A method of information processing according to the first embodiment includes obtaining first contents and second contents, and storing the obtained first contents and second contents. The method further includes reading the stored first contents and second contents and outputting the second contents, while causing the second contents to precede the first contents a predetermined time, to be superimposed on the first contents.

A computer program according the first embodiment includes the steps of: obtaining first contents and second contents; storing the obtained first contents and second contents; and reading the stored first contents and second contents and outputs the second contents, while causing the second contents to precede the first contents a predetermined time, to be superimposed on the first contents.

A computer program recorded on a recording medium according to the embodiment includes: obtaining first contents and second contents; storing the obtained first contents and second contents; and reading the stored first contents and second contents and outputting the second contents, while causing the second contents to precede the first contents a predetermined time, to be superimposed on the first contents.

An information processing apparatus according to a second embodiment of the invention includes: an obtaining unit obtaining first contents and second contents; a storage storing the first contents and second contents obtained by the obtaining unit; and an information processor reading the first contents and second contents stored in the storage and outputting the second contents, while causing the second contents to precede the first contents a predetermined time, to be superimposed on the first contents.

The information processing apparatus according to the first embodiment obtains first contents and second contents, and causes the second contents to precede the first contents a predetermined time, relative to the first contents. The apparatus further outputs the second contents, while causing the second contents to precede the first contents a predetermined time, to be superimposed on the first contents.

The information processing apparatus according to the second embodiment obtains the first contents and second contents, and outputs the second contents to be superimposed on the first contents.

The embodiments of the invention will make audience efficiently understand contents of the television broadcasting program.

### BRIEF DESCRIPTION OF THE DRAWINGS

FIG. 1 is a configuration diagram of an information processing apparatus according to a first embodiment of the invention in an information presentation system.

FIG. 2 is an explanatory diagram illustrating a concept of simultaneously presenting contents of a counterprogram according to the first embodiment of the invention.

FIG. 3 is a flow-chart illustrating a processing example of simultaneously presenting the contents of counterprogram according to the first embodiment of the invention.

FIG. 4 is an explanatory diagram illustrating a concept of time preceding presentation of a program according to a second embodiment of the invention.

FIG. 5 is a flow-chart illustrating a processing example of time preceding presentation of the program according to the second embodiment of the invention.

FIG. 6 is an explanatory diagram illustrating a concept of time preceding presentation of a counterprogram according to a third embodiment of the invention.

FIG. 7 is a graph illustrating one example of a sound volume change in a currently presenting program and counterprogram according to the embodiments of the invention.

FIG. 8 is a block diagram illustrating one example of internal configuration of a personal computer according to the embodiments of the invention.

### DESCRIPTION OF THE PREFERRED EMBODIMENTS

Preferred embodiments of the present invention will now be described with reference to the accompanying drawings. The embodiments described below are merely specific examples that have various technologically preferred limitations; however, the invention is not limited thereto, unless otherwise specified in the following description. Specifically, processing time, processing order, and a numerical condition for each parameter illustrated in the following description are merely suitable examples, and shapes and locations of components in each drawing merely illustrate one schematic example.

FIG. 1 is a schematic configuration diagram of an information processing apparatus an according to embodiments (first to fourth embodiments) of the invention in an information presentation system. As shown in FIG. 1, the information presentation system includes information processing apparatus 1 receiving a television broadcasting wave and obtaining contents therefrom, carrying out certain processing described later on the contents to output the resulting contents, and a display unit 2 displaying the resulting contents output by the information processing apparatus 1. The information processing apparatus 1 includes a tuner 3, a storage 4, an information processor 5, a sound transducer 6, and input unit 7.

The tuner 3 receives and demodulates the television broadcasting wave that is designated by the user (viewer) from television broadcasting waves, each having a plurality of channels containing programs (i.e., television broadcasting signals), via an antenna which is not shown in the figure. The tuner 3 indicates one example of an obtaining unit in a broader concept. According to the embodiment, the information processing apparatus 1 includes two or more tuners 3 that simultaneously receive television broadcasting signals having two or more channels, that is, a double-tuner or triple-tuner. Alternatively, the broadcasting may be satellite broadcasting in place of television broadcasting. The broadcasting can either be digital or analog.

The storage 4 indicates one example of a recording unit in a broader concept that can temporarily store or record the television broadcasting programs (hereinafter, simply called “programs” or “program”) contained in the television broadcasting waves that have been received by the tuner 3. In a case where the information processing apparatus 1 includes two or more the tuners 3, the storage 4 records and stores the programs that have each been received by the tuners 3. Examples of the storage 4 include a Hard disk drive (HDD) and a semiconductor memory. The number of the storages 4 provided may correspond to the number of the tuners 3. Alternatively, one storage 4 may be divided into a plurality of partitions or regions so as to record the programs received by the tuners 3 in the respective regions thereof.

The information processor 5 includes an image processor 5A and sound processor 5B. The information processor 5 decodes the respective programs (contents) recorded in the storage 4 to split the programs into image signals and sound signals, and transmits the image signals and sound signals to the image processor 5A and sound processor 5B, respectively. In addition, the information processor 5 controls an entire operation of the information processing apparatus 1, and gives instructions to components in the information processing apparatus 1 in accordance with input signals input from the input unit 7 operated by the user.

The image processor 5 controls the information processor 5A based on the user's instructions to output the image signals contained in the television broadcasting programs (contents), which the information processor 5 has read out of the storage 4, to the display unit 2 described later. The image signals may hereinafter be referred simply to as “images”.

The sound processor 5B outputs the sound signals contained in the television broadcasting programs (contents), which are read out of the storage 4 by the information processor 5, to speakers 2L, 2R mounted on the display unit 2 based on the user's request. The sound processor 5B can superimpose different sound signals on the sound signals of the program currently being viewed, which includes identical sound thereto but presented in shifted time base, to output the resulting sound. The sound signals may hereinafter be referred simply to as “sound”.

The sound transducer 6 transduces the sound signals of the television broadcasting program that have been read out of the storage 4 by the information processor 5. Various sound transducing systems may be employed; however, detailed descriptions thereof will be provided later.

The input unit 7 receives input signals of channel selected by the user via a remote controller (not shown), and transmits the signals to the information processor 5. The programs of the channel that the user has selected based on the input signals received by the input unit 7 are read out of the storage 4, and the image and sound signals received are decoded to form images and sound via the image processor 5A and sound processor 5B.

The display unit 2 displays the image of the program on the display screen 2A based on the image signals input from the image processor 5A. The display unit 2 also outputs (generates) sound from the speakers 2L, 2R based on the sound signals input from the sound processor 5B. Examples of the display unit 2 include a liquid crystal display (LCD), organic electro luminescence display, plasma display, field emission display (FED), cathode ray tube (CRT). The display unit 2 may be a display system including a plurality of display units, that is, a so-called multiple-display. In this embodiment, the display unit 2 has the speakers 2L, 2R on the both sides thereof; however, the display unit 2 may include separate speakers 2L, 2R independent of the display unit 2.

In this embodiment, examples of contents include television broadcasting programs received by the tuners 3; however, the contents are not limited thereto. The contents may be a plurality of image contents and sound contents stored in an external recording medium such as removable media, so as to record the contents on each of the regions of the storage 4. The image contents can either be dynamic or static.

### First Embodiment

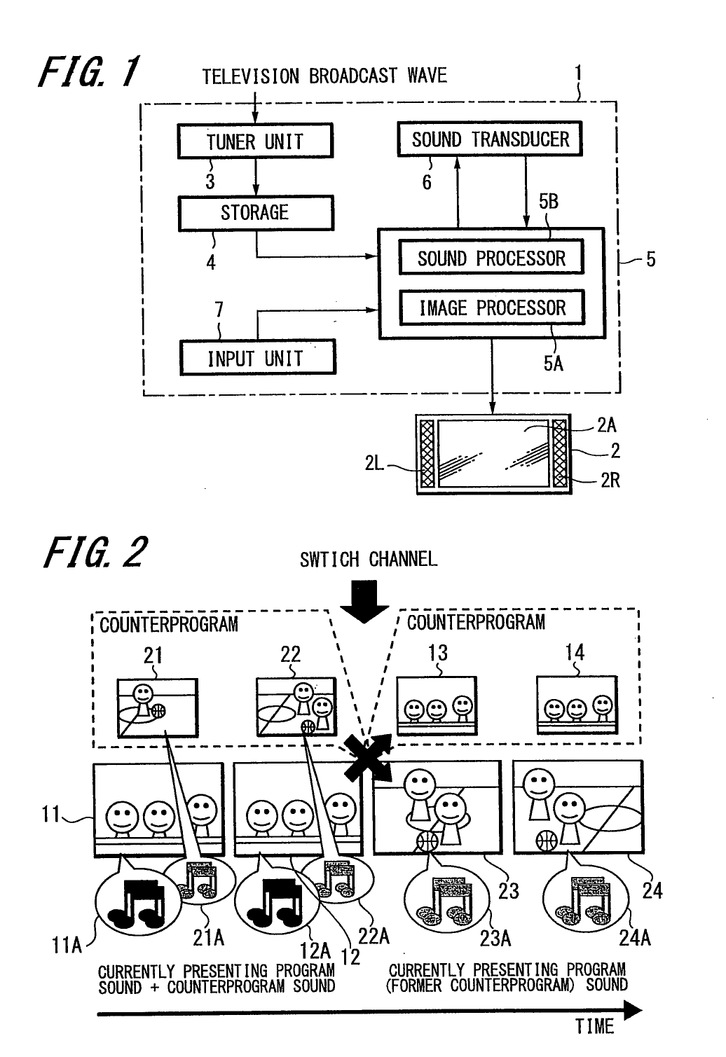

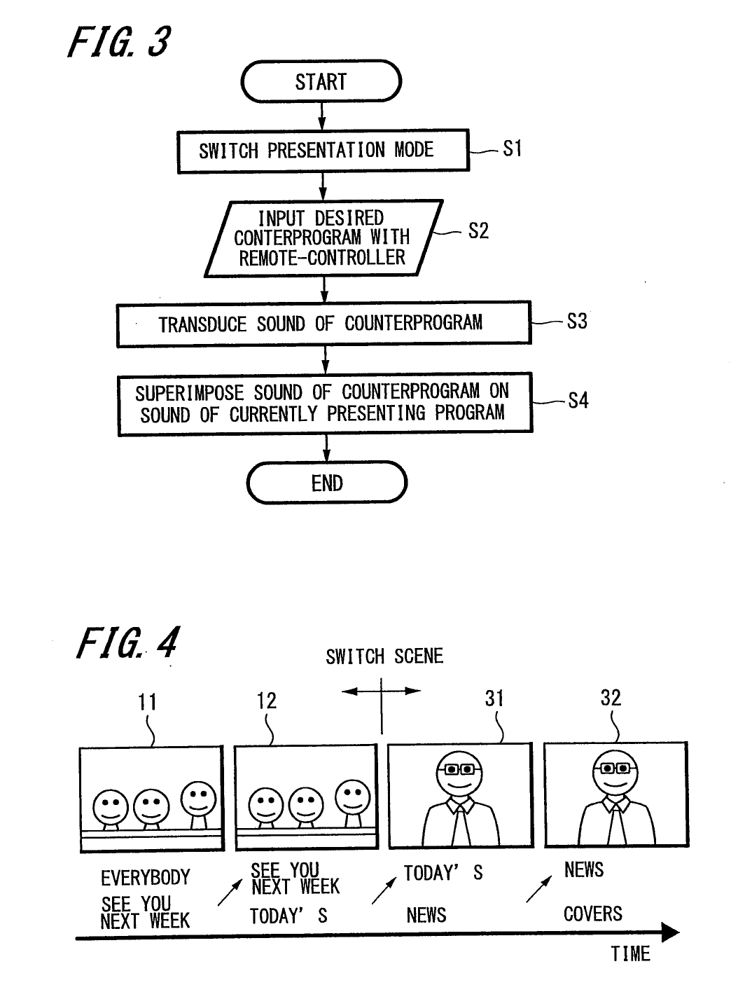

The first embodiment of the invention will be described with reference to FIG.2 and FIG. 3.

The first embodiment includes “simultaneously presenting a counterprogram” in which the first information processing apparatus obtains first contents and second contents, and superimposes sound of the second contents on sound of the first contents to output the first contents. The plurality of contents of the first embodiment can be displayed on a multiple-display either as a currently presenting program or a counterprogram; however, in the following example, the currently presenting program and counterprogram are displayed on one display screen of the display unit 2 as the plurality of contents.

A concept “simultaneously presenting a counterprogram” will now be described with reference to FIG. 2. In FIG. 2, when the display unit 2 displays images 11, 12 of first contents as the currently presenting program, images 21, 22 of second contents are output to the display unit 2 as the counterprogram that is display-controlled by the image processor 5A. At this moment, the sound processor 5B superimposes sound 21A, 22A of the counterprogram on sound 11A, 12A of the currently presenting program to output the resulting sound to speakers 2L, 2R. Thus, the user will hear the mixed sound of currently presenting program sound 11A, 12A and the counterprogram sound 21A, 22A.

When the currently presenting program is switched to counterprogram, the image processor 5A controls the first contents images 11, 12 of the currently presenting program to be displayed as the counterprogram, and the second contents images 21, 22 of the counterprogram to be output to the display unit 2 as the currently presenting program. Simultaneously, the second contents sound 23A, 24A of the former counter program is output to the speaker 2L, 2R as sound of currently presenting program.

In a mode of simultaneously presenting counterprogram, when switching the channels in general, an image 23 is displayed on the display unit 2 as the currently presenting program, with a delay for switching the channel of counterprogram to that of currently presenting program. In an example of FIG. 2, an image 21 displayed includes a basketball match. In image 21, the first team is forwarding from left to right while in an image 22, the second team has intercepted a ball, is forwarding from right to left, and is advancing close to the center circle. In the image 23 having the same contents as the image 21 after switching the channel, the team has advanced to the center circle, and in a next image 24, the second team is advancing into the first team site (territory).

Consequently, the counterprogram is simultaneously presented to the user while presenting the currently presenting program, so that the user obtains information on the counterprogram. Specifically, since the user has been heard the sound of counterprogram before the current channel is switched to the counterprogram, the user can follow the contents of the program immediately after the channel is switched.

A processing example of simultaneously presenting a counterprogram is described with reference to FIG. 3. First, the user switches a current mode to the simultaneously presenting the counterprogram mode using a remote controller while the user is viewing the currently presenting program (first contents). At this time, a signal corresponding to user's operation is input to the information processor 5 via the remote controller, and the mode of the display unit 2 is switched to the simultaneously presenting the counterprogram (step S1).

Next, the information processor 5 controls the image processor 5A to display a counterprogram selection screen on the display unit 2 in order to prompt the user to select which of counterprograms the user would desired to be presented on the simultaneously presenting counterprogram mode; that is, to select which sound of counterprograms the user would superimpose on the sound of the currently presenting program to hear. The user selects one of counterprograms displayed on the simultaneously presenting contents selection screen of the display unit 2 by controlling the remote controller so as to superimpose the sound of counterprogram the user wishes to on the sound of currently presenting program (step S2).

The tuners 3 select and receive the counterprogram designated by the user, and store the received counterprogram in the storage 4. The information processor 5 reads out the selected counterprogram of the storage 4 and transfers the counterprogram to the sound transducer 6. The sound transducer 6 transduces the sound of counterprogram received from the information processor 5 to suppress two units of sound, that is, one from the currently presenting program and the other from the counterprogram, from being merged when superimposing the two units of sound (step S3).

Examples of sound transduction include the application of effect or sound effect, such as reducing the sound gain of counterprogram that will be superimposed, pitch-conversion, lowpass filtering, and reverberating. Thus, having applied such effect on the sound of counterprogram, the user will be able to perceive the difference between the sound of currently presenting program and that of counterprogram. Specific examples of the sound transduction will be described later.

The sound processor 5B receives the transduced sound of counterprogram from the sound transducer 6, superimposes the transduced sound on the sound of currently presenting program viewed by the user, and output the resulting sound to the speakers 2L, 2R (step S4).

In simultaneously presenting the counterprogram of the first embodiment, since the sound of counterprogram has been superimposed on the sound of currently presenting program viewed by the user, the user can grasp a certain level of the contents of counterprogram by the presentation of superimposed sound of counterprogram on the currently presenting program. Thus, the user will follow the contents of counterprogram immediately after switching the counterprogram to the currently presenting program.

Further, the user can obtain the information on the program desired by the user (counterprogram) by switching the channel of the sound of counterprogram to be superimposed while viewing the currently presenting program.

### Second Embodiment

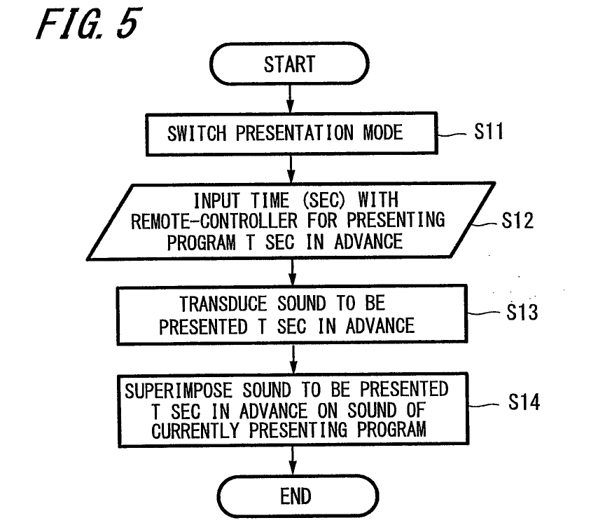

Next, the second embodiment of the invention will be described with reference to FIG. 4 and FIG. 5. The second embodiment is concerned with a concept of “time preceding presentation”, in which the information processing apparatus 1 obtains the first contents, and output the second contents, while causing sound of the second contents to precede the first contents a predetermined time, superimposes the sound of the second contents on the sound of the first contents, to be superimposed on the first contents. In this case, the same sound of the contents can be referred to as the first contents and second contents by presenting the same sound with time difference.

FIG. 4 illustrates a concept of “time preceding presentation” with reference to FIG. 4. In FIG. 4, images 11, 12, 31, 32 of the program currently presenting are sequentially displayed on the display unit 2, a main sound of the currently presenting program preceded by a predetermined time (several sec to several tens of sec) is superimposed and output to the speakers 2L, 2R.

For example, when an image 11 of a program (e.g., a panel show) selected by the user is displayed on the display unit 2, the main sound “See you next week!” that will be presented several sec in advance of the actual reproducing time is superimposed on the main sound “Everybody” that is currently presented, and the superimposed sound is output to the speakers 2L, 2R. Similarly, when an image 12 of the program is displayed on the display unit 2, the main sound “Today's” that will be presented several sec in advance of the actual reproducing time is superimposed on the main sound “See you next week!” that is currently presented, and the resulting sound is output to the speakers 2L, 2R. Subsequently, when the scene of the program is switched and an image 31 of the news program is displayed on the display unit 2, the main sound “news” that will be presented several sec in advance of the actual reproducing time is superimposed on the main sound “Today's” that is currently presented, and the resulting sound is output to the speakers 2L, 2R. Subsequently, when the scene of the program is switched and an image 32 of the news program is displayed on the display unit 2, the main sound “news” that will be presented several sec in advance of the actual reproducing time is superimposed on the main sound “covers” that is currently presented, and the resulting sound is output to the speakers 2L, 2R.

In time preceding presentation, having designated by the user while the user is viewing the program, since the user can hear the main sound presented a predetermined time in advance that is superimposed on the main sound currently presented, the user can view the contents of the program, such as the change or climax of the scene, with some previous knowledge of the contents. Accordingly, the user will understand the contents of the currently presenting program more efficiently. For example, the user will not miss a flash of the scene that is displayed in a brief moment. In other words, presenting some of the contents a predetermined time in advance has the same effect as replaying (rewinding) part of images of the athletic match. Further, since the user hears the same sound or voice twice; that is, the original sound and superimposed sound, the user will easily remember the sound or voice, which will eventually facilitate the understanding of the user.

With the superimposed sound of the program, it is preferable to carry out sound transduction on the sound thereof in the same manner as the case of “simultaneously presenting a counterprogram” of the first embodiment, so that the original sound and superimposed sound will not merge.

A processing example of time preceding presentation is described with reference to the flowchart of FIG. 5. First, the user switches a current mode to a time preceding presentation mode with a remote controller while the user is viewing a desired program. At this time, a signal corresponding to user's operation is input to the information processor 5 via the input unit 7 with the remote controller, and the mode of the display 2 is switched to the time preceding presentation mode (step S11).

Next, the information processor 5 controls the image processor 5A to display a time specification screen on the display unit 2 so as to prompt the user to specify time T (sec) to cause the sound to precede, and superimpose the sound on the main sound currently presented. The user specifies the preceding time T on the time specification screen of the display unit 2 by controlling the remote controller (step S12).

The information processor 5 sets the preceding time T specified by the user. Then, the information processor 5 reads the main sound of the contents the specified time T sec in advance of that of the currently presenting program out of the storage 4, and transfer the read sound to the sound transducer 6. The sound transducer 6, while superimposing the main sound of the contents obtained T sec in advance on the main sound of the contents currently presented, transduces the sound of the contents obtained T sec in advance received from the information processor 5, so that two units of main sound, specifically, one from the current scene and the other from the next scene, is suppressed from being merged (step S13). Specific examples of the sound transduction will be described later.

The sound processor 5B receives from the sound transducer 6 the transduced main sound of the contents obtained T sec in advance of the main sound currently presented, superimposes the transduced main sound on the main sound of currently presented program viewed by the user, and outputs the resulting main sound to the speakers 2L, 2R (step S14).

According to the time preceding presentation of the aforementioned second embodiment, since the main sound of the contents obtained T sec in advance is superimposed on the main sound of the contents currently presented, the user will understand the program currently presenting more efficiently. For example, hearing the sound of the same contents a plurality of times will provide effects such as the user's profound understanding and facilitation of the user's remembering of the contents of the program.

Further, the user obtains some knowledge in advance on some of the events currently presented based on the sound thereof, the user will not miss the important scenes of the program.

### Third Embodiment

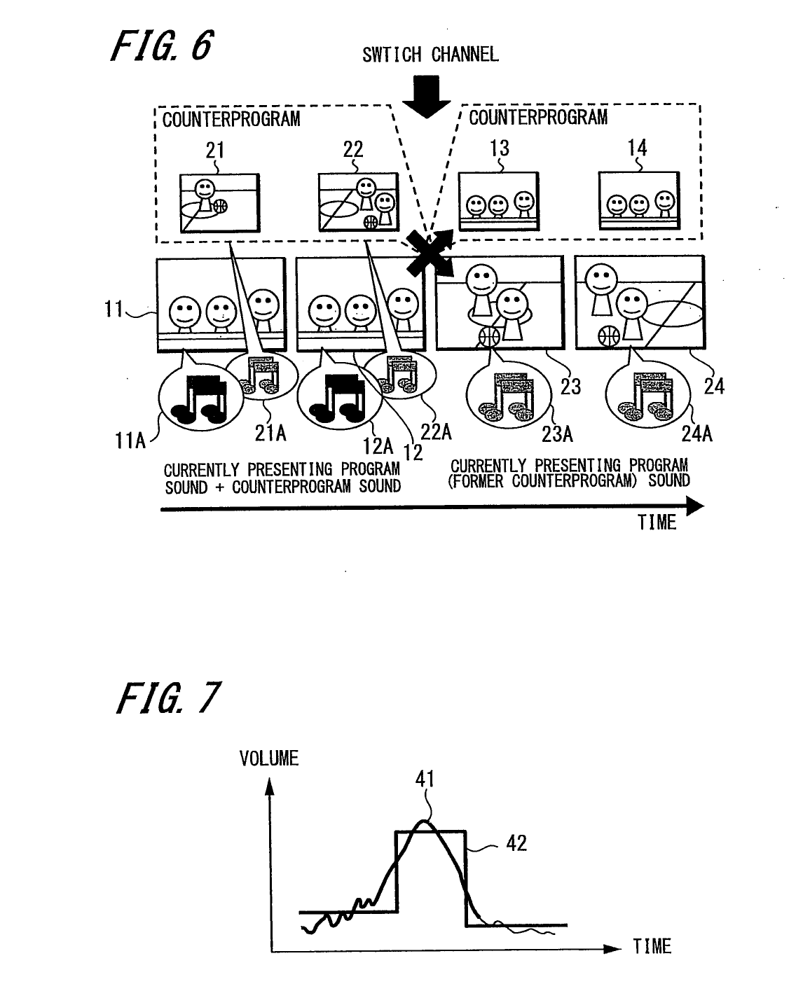

The third embodiment of the invention will be described with reference to FIG. 6.

The second embodiment includes “time preceding presentation of a counterprogram” in which the first information processing apparatus obtains first contents and second contents and outputs the second contents, while causing sound of the second contents to precede the first contents a predetermined time, to be superimposed on sound of the first contents. A concept of “time preceding presentation of a counterprogram” is derived from a combination of the aforementioned embodiments “simultaneously presenting a counterprogram” and “time preceding presentation”. The plurality of contents of the third embodiment can be displayed on a multiple-display either as a currently presenting program or as a counterprogram; however, in the following example, the currently presenting program and counterprogram are displayed on one display screen of the display unit 2 as the plurality of contents.

FIG. 6 illustrates a concept of “time preceding presentation of a counterprogram” with reference to FIG. 6. In FIG. 6, when the display unit 2 displays first images of contents 11, 12 as the currently presenting program, second images of contents 21, 22 are output to the display unit 2 as the counterprogram by the display-control of the image processor 5A. At this moment, the sound processor 5B superimposes sound 22A, 23A corresponding to images 22, 23 of counterprogram, which precede currently presenting program a predetermined time relative to sound 11A, 12A of the currently presenting program, on the sound 11A, 12A, respectively, and outputs the resulting sound to speakers 2L, 2R. Thus, the user will hear the mixed sound of currently presenting program sound 11A, 12A and the counterprogram sound obtained a predetermined time in advance 22A, 23A.

Then, when the currently presenting program is switched to counterprogram, the image processor 5A controls the first contents images 13, 14 of the currently displaying program before being switched to be output to the display unit 2 as the counterprogram, and also controls the second contents images 23, 24 of the counterprogram before being switched as the currently presenting program. Simultaneously, the second contents sound 23A, 24A displayed as the counterprogram before being switched, is output to the speaker 2L, 2R as sound of currently presenting program.

In a mode of time preceding presentation of a counterprogram, when switching channels in general, an image 23 is displayed as the currently presenting program on the display unit 2, which is an image presented with delay that is required for switching the channel of counterprogram to that of currently presenting program. Similar to the example of FIG. 2, in an example of FIG. 6, an image 21 displays a basketball match. In image 21, the first team is forwarding from left to right while in an image 22, the second team has intercepted a ball, is forwarding from right to left, and is advancing close to the center circle. In the image 23 having the same contents as the image 21 after switching the channel, the team has advanced to the center circle, and in a next image 24, the second team is advancing into the first team site (territory).

As described in the first embodiment, the user obtains knowledge of what is happening in the counterprogram by hearing the sound of counterprogram superimposed on the currently presenting program. However, in this case, by the preceding time that the user has noticed the change in the counterprogram and has operated the remote controller to switch the channel, there may no longer be the change presented on the display, so that the user may miss the change. Thus, in the time preceding presentation of a counterprogram mode, the sound of counterprogram to be superimposed is presented in advance of the sound of currently presenting program. Alternatively, the some contents of currently presenting program are presented with delay relative to the counterparts of counterprogram, so that time for switching the channel can be secured. In other words, the counterprogram is replayed when the counterprogram has been traced back to the preceding time that the user has switched the channel. The repeated presentation of the sound 23A of the second contents implies that the user hears the same sound of the contents repeatedly. In this manner, the delay caused by the user's switching the channel of currently presenting program to that of counterprogram using a remote controller can be compensated, so that the user will not miss the information.

The user can directly operate a remote controller to specify the time required for switching the channel, specifically, the preceding time T for presenting the couterprogram in advance. Alternatively, it is possible to determine the preceding time T based on the learning model with which the preceding time T is properly changed according to the user. If the preceding time T is determined based on the learning model, the user will be asked to operate a remote controller several times, and the time used for operating the remote controller are individually measured. Then, the preceding time T is determined by multiplying the measured time by the safety factor.

Next, a processing example of time preceding presentation of a counterprogram will be described. Basically, the processing of time preceding presentation of a counterprogram can be described with reference to the flowchart of FIG. 5. However, there are differences in the steps from the flowchart of FIG. 5; that is, in step S11, the user selects a time preceding presentation of a counterprogram mode instead of a time preceding presentation mode, and in step S12, the counterprogram is subject to being presented a predetermined time T in advance instead of currently presenting program.

First, the user switches a current mode to the time preceding presentation of a counterprogram mode with a remote controller while the user is viewing a desired program. At this time, a signal corresponding to user's operation is input with the remote controller to the information processor 5 via the input unit 7, and the mode of the display 2 is switched to the time preceding presentation of a counterprogram mode (corresponding to step S11).

Next, the information processor 5 controls the image processor 5A to display a counterprogram selection screen on the display unit 2 in order to prompt the user to select which of counterprograms the user would desire to be presented on the time preceding presentation of a counterprogram mode; that is, to select which sound of counterprograms the user would superimpose on the sound of the currently presenting program to hear. The user selects one of counterprograms displayed on the time preceding presentation of a counterprogram selection screen of the display unit 2 by controlling the remote controller so as to be superimposed on the sound of currently presenting program. The user also specifies what duration of time the user wishes to cause the counterprogram to precede so as to be superimposed on the sound of currently presenting program (real-time program). For example, the information processor 5 displays the time specification screen on the display unit 2 to prompt the user to specify the preceding time T (sec). The user specifies the preceding time T on the time specification screen of the display unit 2 by controlling the remote controller (corresponding to step S12).

The information processor 5 sets the preceding time T specified by the user. Then, the information processor 5 reads the sound of the contents of counterprogram from the storage 4 a specified time T sec in advance, and transfers the sound preceded by the specified time T sec to the sound transducer 6. The sound transducer 6, when superimposing the sound of counterprogram preceded by T sec on the sound of the currently presenting program, transduces the sound of counterprogram preceded by T sec received from the information processor 5, so that two units of sound are suppressed from being merged (corresponding to step S13). Specific examples of the sound transduction will be described later.

The sound processor 5B receives from the sound transducer 6 the transduced the sound of counterprogram preceded by T sec, superimposes the transduced sound on the sound of currently presenting program viewed by the user, and output the resulting sound to the speakers 2L, 2R (corresponding to step S14).

According to the time preceding presentation of a counterprogram of the aforementioned third embodiment, since the sound of counterprogram preceded by T sec is superimposed on the sound of the currently presenting program, there is an effect with which the user will be notified in advance what will happen in the counterprogram.

In addition, the delay caused by the user's switching the channel of currently presenting program to that of counterprogram using a remote controller can be compensated, thereby preventing the user from missing the information.

### Fourth Embodiment

Next, the superimposed sound presentation according to the first to the third embodiments will be described. In this embodiment, the sound superimposed on the sound of currently presenting program is transduced, so that the two units of sound will differ to easily be identified by the user. There are roughly three methods for sound processing: (a) volume, (b) frequency, and (c) location of sound source.

With the sound processing technique, the user hears the main sound of currently presenting program without being disturbed by the sub-sound of counterprogram. It is preferable that the user understand the content of counterprogram via the sub-sound thereof when the user concentrates on the program, or roughly grasp the outline thereof (the change of the sound or tone of the voice) even when the user do not. “Superimpose sound” simply implies that one sound is superimposed on another to present the resulting sound.

### (a) Volume

1. The volume of sound of counterprogram to be superimposed is lowered in comparison to sound of currently presenting program.

2. The volume of sound of counterprogram is adjusted based on the volume of the sound of currently presenting program (e.g., typical peak detection). Thus, the volume of sound of counterprogram is usually low when the sound of currently presenting program has indistinct change, whereas the volume of counterprogram is high when the sound of currently presenting program includes some sensational change. FIG. 7 is a graph illustrating one example of a comparison in volume change between the sound 41 of currently presenting program and the sound 42 of counterprogram. Thus, the sound of counterprogram will be adjusted based on a condition including rise time, fall time, a peak value, and the like of the sound 41 of currently presenting program.

3. The volume of sound of counterprogram is adjusted in compliance with movement of counterprogram. For example, the sound will be lowered when there are a few movements, whereas the sound will be increased when there are lots of movements represented by frequent telop appearances or frequent scene changes in a scene. An example of a scene image analysis includes analyzing the absolute difference obtained from an image signal field or image signal frame.

4. The volume of sound of the counterprogram is adjusted based on a user's operation with a remote controller. For example, the user operates to increase the volume of counterprogram with the remote controller, indicating that the user does not concentrate on the currently presenting program, otherwise the volume is lowered.

### (b) Frequency

1. Pitch modification: The fundamental frequency of sound of counterprogram is deviated from the ordinary bandwidth by increasing or decreasing the pitch (entire frequency) thereof against the sound of currently presenting program, so that the user can easily discriminate the sound of counterprogram from that of currently presenting program. The sound with reduced pitch is usually more easily discriminated than that with increased pitch though the preference much varies among the audience of the program.

2. Reverberation: The sound of counterprogram that has been reverberated is superimposed on the sound of currently presenting program, so that the user feels the sound source of counterprogram in a distance and easily discriminates the sound of counterprogram from that of currently presenting program.

### (C) Location of Sound Source: Speaker Arrangement, Phase Difference, Volume Difference, Virtual Surround

1. Using a multiple speaker system, a main speaker is assigned to the sound of currently presenting program whereas a sub-speaker is assigned to the sound of counterprogram. Alternatively, L-channel is assigned to the sound of currently presenting program whereas R-channel is assigned to the sound of counterprogram, so that the user easily discriminates the sound of counterprogram from that of currently presenting program.

2. The sound source generated is pseudo-changed based on the phase difference and volume difference, so that the user easily discriminates the sound of counterprogram from that of currently presenting program. For example, an acoustic image of sound of currently presenting program is located at the center between the speakers whereas an acoustic image of the counterprogram is shifted close to the left speaker or right speaker.

3. Pseudo-changing the sound source generated, such as that described in the aforementioned 2, can also be achieved by the virtual surround technology using head-related transfer function.

According to the fourth embodiment described above, since the sound that has been transduced is superimposed on the sound of the program that the user is viewing (e. g., sound of currently presenting program), other sound information (e. g., sound of counterprogram) can easily be presented, in other word, the user can hear the sound of counterprogram without significantly disturbing the user's hearing the currently presented program.

Further, since spatial locations of the sound source are adjusted by allocating the sound to a plurality of speakers, phase differentiation, volume differentiation, virtual surrounding, and the like, the main sound is not significantly disturbed by the superimposed sound, that is, the user can identify the superimposed sound when presented as the different sound information.

In the first to third embodiments, the currently presenting program and the counterprogram of the television waves received by the information processor 1 from the broadcasting station are output to the display unit 2; however, the present embodiments are not limited thereto. For example, a plurality of contents may be stored in the storage 4 via removable media having the contents recorded thereon or via a network, and the plurality of contents read out of the storage 4 by the information processor 5 and then output to the display unit 2.

In the first to third embodiments, the two units of sound are not superimposed (see FIG. 2, FIG. 6) after the channel has been switched; however, the sound of counterprogram (sub-sound) may continuously be superimposed on the sound of currently presenting program (main sound) after the channel has been switched.

As illustrated above, the aforementioned first to third embodiments of the invention describe the case in which the invention is applied to the information processing apparatus that receives and outputs television broadcasting waves to the display unit; however, the invention is not limited thereto. The invention may also be applied to a television tuner having a function to receive television broadcasting waves, or a recording-reproducing apparatus that receives and records television broadcasting waves. Further, the invention may be applied to variety of television receivers such as a mobile telephone, personal computer, and the like that have a function to receive television broadcasting waves, regardless of a display being incorporated therein or separately provided.

A series of processing described above is performed either by hardware or software. When the software performs the series of processing, a computer program constituting the software may have already been installed on a dedicated hardware device of a computer, or may be installed from a computer program recorded media on a versatile computer that can carry out various functions upon installation thereof.

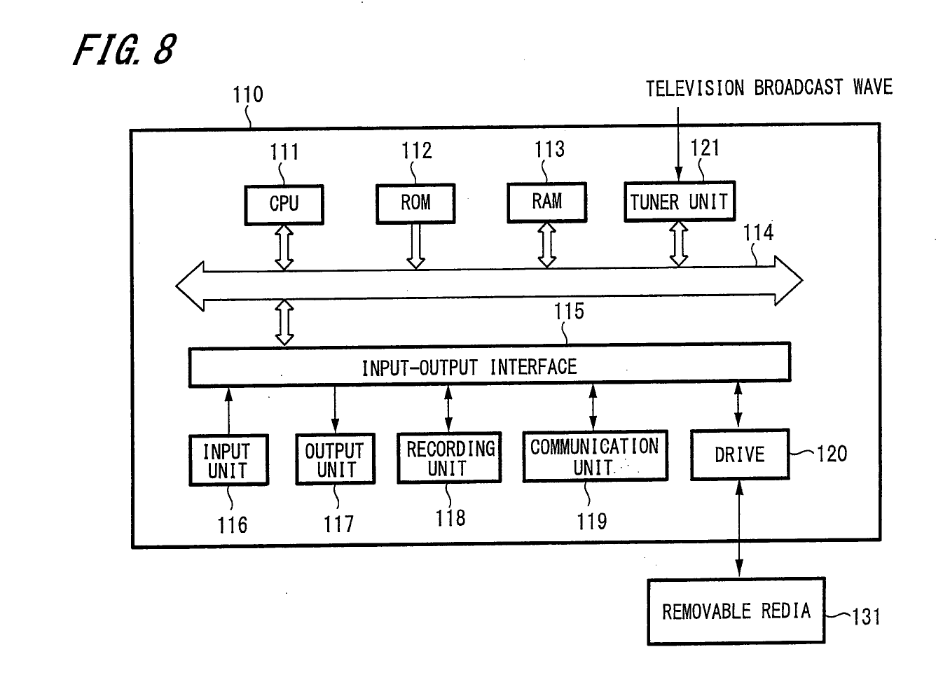

FIG. 8 is a block diagram illustrating a configuration diagram of a personal computer 110 having tuner units that carries out the aforementioned series of processing via a computer program.

A CPU (Central Processing Unit) 111 of the personal computer 110 carries out various processing other than the aforementioned series of processing in compliance with a ROM (Read Only Memory) 112, and the computer program recorded on a recording unit 118. The computer program or data carried out by the CPU 111 is adequately recorded on a RAM (Random Access Memory) 113. CPU 111, ROM 112, and RAM 113 are mutually connected via a bus 114.

An input-output interface 115 is also connected to CPU 111 via the bus 114. An input unit having a keyboard, mouse and microphone, and an output unit 117 having speakers and the like are connected to the input-output interface 115. CPU 111 carries out various processing according to instructions input from the input unit 116. CPU 111 outputs the results of processing to the output unit 117.

The recording unit 118 connected to the input-output interface 115 may be formed of a hard disk, and records a program or data carried out by CPU 111.

A communication unit 119 communicates with external devices via networks such as the internet, local-area network, and the like. The computer program can be obtained and recorded on the recording unit 118 via the communication unit 119.

A drive 120 connected to the input-output interface 115 drives a removable media 131, such as magnetic disk, optical disk, and magneto-optical disk, and acquires the computer program and data recorded thereon upon installation of the removable media 131. The computer program and data acquired can optionally be transferred to and recorded on the recording unit 118.

The tuner 121 receives and demodulates the television broadcasting wave that is designated by the user from television broadcasting waves each having a plurality of channels containing programs (i.e., television broadcasting signals) via an antenna, not shown in the figure. According to the embodiment, the information processing apparatus 110 includes two or more tuners 121 that can simultaneously receive television broadcasting signals having two or more channels.

A recording medium containing a computer program that is installed on the computer and readily executable by the computer may be provided in the form of package media shown in FIG. 8 as removable media 131. Examples of the removable media 131 includes a magnetic disk such as a flexible disk, and optical disk such as a CD-ROM (Compact Disc—read Only Memory), and a DVD (Digital Versatile Memory), a magneto-optical disk, and a semiconductor memory. Alternatively, the computer program recording medium may be formed of the ROM 112 on which a program is temporally or permanently stored or recorded, or a hard disk constituting the recording unit 118.

The computer program is optionally stored in the storage via the communication unit 119 used as an interface, such as a router, modem, or via wired or wireless communication media such as the local-area network, the internet, and digital satellite broadcasting.

In the description, processing steps for describing a computer program recorded on the computer program recording medium includes processing executed in time series according to the described order, or executed in parallel or separately executed (e.g., parallel processing, object oriented processing).

Further, the computer program can be executed on one computer, or can be carried out distributed processing on a plurality of computers. Further, the computer program can be transferred so as to be executed by a remote computer. It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus comprising: an obtaining unit obtaining first contents and second contents;
a storage storing the first contents and second contents obtained by the obtaining unit; and
an information processor reading the first contents and second contents from the storage and outputting the second contents, while causing the second contents to precede the first contents a predetermined time, to be superimposed on the first contents.

2. An information processing apparatus according to claim 1, wherein
the information processor includes an image processor that carries out the predetermined processing on images of the first contents and second contents, and
the information processor includes a sound processor that carries out the predetermined processing on sound of the first contents and second contents.

3. An information processing apparatus according to claim 2, wherein
the first contents and the second contents are a first television broadcasting program and a second television broadcasting program, respectively, and
the image processor and the sound processor output the first television broadcasting program as a currently presenting program, and the second television broadcasting program as a counterprogram.

4. An information processing apparatus according to claim 2, wherein
the first contents and the second contents are an identical television broadcasting program, and
the sound processor outputs the sound of the second contents obtained by causing the sound of the second contents to precede the first contents a predetermined time, while superimposing the sound of the second contents on the sound of first contents.

5. An information processing apparatus according to claim 2, wherein
the sound processor causes sound of the counterprogram to precede the currently presenting program a predetermined time, and outputs the sound of the counterprogram while superimposing the sound of the counterprogram on sound of the currently presenting program.

6. An information processing apparatus according to claim 5, further comprising:
an input unit configured to input instruction by user's operation, wherein
when an instruction to switch the currently presenting program to the counterprogram is input to the input unit, the image processor returns images of the counterprogram before being switched a predetermined time when the instruction has been input, and outputs the images of the counterprogram as images of the currently presenting program, and
the sound processor returns sound of the counterprogram before being switched a predetermined time when the instruction has been input, and outputs the sound of the counterprogram as sound of the currently presenting program.

7. An information processing apparatus according to claim 3, further comprising:
a display unit displaying the images of the currently presenting program output from the image processor.

8. An information processing apparatus according to claim 1, wherein
the first contents and the second contents are images, respectively.

9. An information processing apparatus according to claim 1, wherein
the first contents and the second contents are sound, respectively.

10. An information processing apparatus according to claim 9, further comprising:
a sound transducer that transduces the sound of the second contents, which is superimposed on the sound of the first contents.

11. An information processing apparatus according to claim 10, wherein
the sound transducer adjusts spatial locations of the sound of the first contents and the sound of the second contents.

12. An information processing apparatus comprising:
an obtaining unit obtaining first contents and second contents;
a storage storing the first contents and second contents obtained by the obtaining unit; and
an information processor reading the first contents and second contents from the storage and outputting the second contents to be superimposed on the first contents.

13. A method of information processing comprising the steps of:
obtaining first contents and second contents;
storing the obtained first contents and second contents; and
reading the stored first contents and second contents and outputs the second contents, while causing the second contents to precede the first contents a predetermined time, to be superimposed on the first contents.

14. A computer program causing a computer to execute processing for control of an information processing apparatus, the processing comprising:
obtaining first contents and second contents;
storing the obtained first contents and second contents;
reading the stored first contents and second contents and outputs the second contents, while causing the second contents to precede the first contents a predetermined time, to be superimposed on the first contents.

15. A recording medium having a program recorded thereon for causing a computer to execute processing for control of an information processing apparatus, the processing comprising:
obtaining first contents and second contents;
storing the obtained first contents and second contents;
reading the stored first contents and second contents and outputs the second contents, while causing the second contents to precede the first contents a predetermined time, to be superimposed on the first contents.
